(19) United States
(12) Patent Application Publication
(10) Pub. No.: US 2005/0198882 A1
(43) Pub. Date: Sep. 15, 2005

(54) Display holder

(76) Inventor: Catherine Zaremba, South Barrington, IL (US)

Correspondence Address: BRINKS HOFER GILSON & LIONE, P.O. BOX 10395, CHICAGO, IL, 60610, US

(21) Appl. No.: 11/077,268

(22) Filed: Mar. 10, 2005

Related U.S. Application Data
(60) Provisional application No. 60/552,085, filed on Mar. 11, 2004.

(51) Int. Cl. G09F 3/18

(52) U.S. Cl. 40/654.01; 40/760

(57) ABSTRACT

Device for displaying media as a wall border or banner. The device includes a transparent front member attached to a rear member with at least two pockets for displaying media. The device includes an adhesive layer on a rear surface of the rear member, allowing it to be mounted on a substantially smooth mounting surface. In different embodiments the adhesive layer is permanently or removably adhesive.

### CROSS-REFERENCE TO RELATED APPLICATIONS

This application claims priority to U.S. Provisional Application Ser. No. 60/552,085, filed Mar. 11, 2004.

### TECHNICAL FIELD

The present invention relates to a display holder suitable for use as a decorative wall border or banner for holding and displaying different media (e.g. photographs, greeting cards, postcards, stenciled letters, etc.).

### BACKGROUND

Media including memorabilia such as photographs, greeting cards, postcards, and the like are commonly displayed in picture frames or albums. Such displays provide an opportunity for easy viewing of the desired objects. A number of prior art devices are used for this purpose, most commonly with the goal of allowing easy viewing of an object or set of objects while preserving the objects' appearance. For example, mounting media such as a photograph in a frame with a glass front provides both for protection of the media and ease of viewing. A variety of album styles exist, some of which offer only easy viewing, but do not provide protection for the media being displayed.

One prior art device, a protective photo holder (U.S. Pat. No. 4,771,557), provides a protective sleeve for mounting a photograph. The protective sleeve is adapted for permanently mounting the sleeve into an album or onto some other surface. This sleeve device has a permanent adhesive that provides a long-term solution for mounting. A variety of refrigerator magnets, mountable frames, and other holders also offer the ability to display media on different mounting surfaces.

Other media displays use permanently imprinted banners or a series of pictures, letters, or patterns fashioned of paper or plastic strung together. For example, one form of a display is a banner featuring a pre-printed message on the banner. Another form of banner might consist of letters, such as H-A-P-P-Y-A-N-N-I-V-E-R-S-A-R-Y, printed on, or cut out of separate pieces of, paper and strung together to be hung for display.

Each of these prior art devices is quite versatile in being able to display any appropriately-sized media of a user's choice. However, even with respect to the media display devices readily mountable on a mounting surface such as a wall, refrigerator, or bulletin board, there are some limits. Specifically, there is no single holding device for displaying a series of readily interchangeable media as a decorative wall border or banner that removably adheres to a mounting surface.

As used herein, “removably adheres” refers to an object's capacity (1) to be adhered to a mounting surface; (2) to be removed from that surface without substantially altering the surface or leaving a substantial residue thereupon; and (3) thereafter to be adhered to the same or another mounting surface.

Also as used herein, “permanently adheres” refers to an object's capacity to be adhered to a mounting surface such that the object cannot be moved or removed relative to the mounting surface after a permanent adhesive bond has formed between the object and the mounting surface. The permanent adhesive bond between the object and the mounting surface may form immediately. Alternatively, the permanent bond between the object and the mounting surface may form after an interim time period during which the object is movable relative to the mounting surface.

### SUMMARY OF THE INVENTION

The present invention provides a novel and useful advance in the form of a holder for displaying media in a protective pocket that is mountable as a wall border or decorative banner. Various embodiments provide for temporary or permanent display of a broad variety of media. In particular, the embodiments herein described are well adapted for displaying media as a decorative wall border or banner. Specifically, the present invention offers a user the ability to display a personalized, unique, and changeable array of media as a single, continuous decorative wall border. The highly customizable nature of the holder offers a distinct advantage over the prior art.

In one aspect, the invention comprises a holder for displaying media, wherein the holder has a transparent front member attached to a rear member. The rear member comprises a front surface and a rear surface. The rear surface of the rear member comprises an adhesive layer. The front member is attached to the rear member in a manner forming a series of at least two pockets, each having at least one open side. Each of the at least two pockets is sized to hold at least one piece of media. The media displayed is preferably of a size, thickness, and weight that will not interfere with the holder's adhesion to a mounting surface.

Different adhesives may comprise the adhesive layer. In one embodiment, the adhesive layer removably adheres the holder to a substantially smooth mounting surface. In a second embodiment, the adhesive layer immediately and permanently adheres the holder to a substantially smooth mounting surface. In a third embodiment, the adhesive layer initially forms a removably adhesive bond to permit relocation and reorientation of the holder for up to about 24 hours after initial mounting of the holder to the mounting surface. After about 24 hours, the holder is permanently adhered to the mounting surface.

A number of variations in the appearance of the holder are possible and are described below. The embodiments described are not intended to be exclusive. For example, each of the aesthetic differences described in different embodiments may be used in concert with each other or with any of the disclosed adhesive embodiments.

### BRIEF DESCRIPTION OF THE DRAWINGS

FIG. 1A is a front view of one embodiment of a wall border display holder;

FIG. 1B is a transverse cross-sectional view thereof, taken along line 1B-1B of FIG. 1A;

FIG. 2A is a front view of another embodiment of a display holder;

FIG. 2B is a transverse cross-sectional view thereof, taken along line 2B-2B of FIG. 2A;

FIG. 3A is a front view of yet another embodiment of a display holder;

FIG. 3B is a transverse cross-sectional view thereof, taken along line 3B-3B of FIG. 3A; and

FIG. 4 is a front view of still another embodiment of a display holder, shown as a banner.

### DETAILED DESCRIPTION OF THE DRAWINGS AND THE PRESENTLY PREFERRED EMBODIMENTS

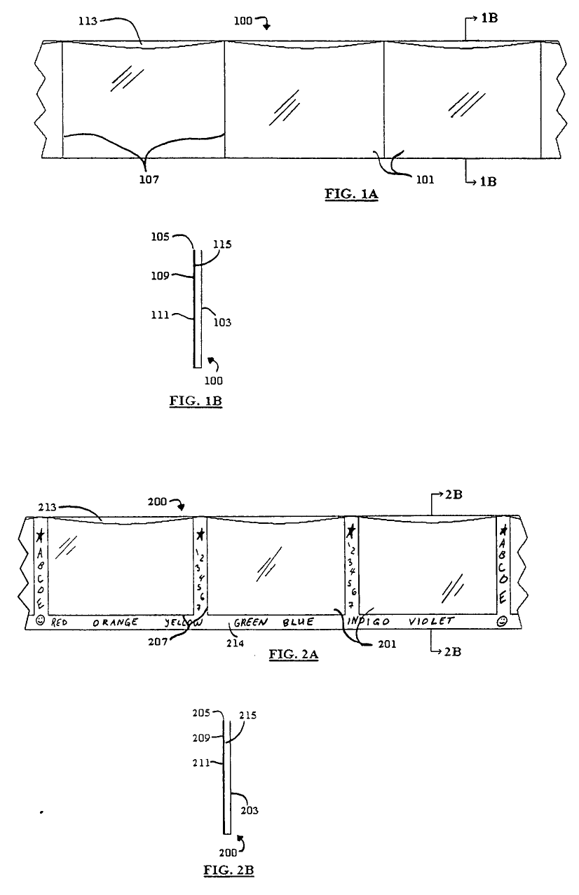

FIGS. 1A and 1B show one embodiment of the invention, shown as a wall border display holder. FIG. 1B is a transverse cross-sectional view along line 1B-1B of FIG. 1A (not to scale). The holder 100 includes a linear series of rectilinear plastic pockets 101 having a transparent front member 103 attached to a rear member 105. Front member 103 and rear member 105 preferably are constructed of material(s) that will not cause harm to media in pockets 101. For example, a low-acid, or acid-free, plastic will not cause colors of photographs held by pockets 101 to fade.

Pockets 101 are separated and delineated by attachment seams 107. The means for forming seams 107 between front member 103 and rear member 105 may be an adhesive, a thermal bonding process, a crimping process, some combination thereof, or other means suitable for permanently or removably attaching front member 103 to rear member 105.

The rear surface 109 of rear member 105 includes an adhesive layer 111 used to adhere holder 100 to a wall or other substantially smooth mounting surface (not illustrated). Adhesive layer 111 comprises a pressure-sensitive, medium tack adhesive that allows the holder to be removably adhered to a mounting surface. Alternatively, adhesive layer 111 comprises a high-tack adhesive that immediately permanently adheres the holder 100 to a mounting surface. In yet another alternative, adhesive layer 111 comprises an adhesive that initially permits relocation and reorientation of the holder relative to the mounting surface for up to about 24 hours after an initial adhering of the holder to the mounting surface. After about 24 hours, a permanent bond forms between the adhesive layer 111 and the first mounting surface, thereby permanently adhering the holder to the mounting surface. Any of these adhesive embodiments may be used with the variety of display holder embodiments described below. Specifically, each of the different holder configurations described below may either be removably or permanently adhered to a mounting surface. Additionally, the adhesive may, for purposes of convenience in packaging and user-friendliness, be covered with a peel-off backing of a type well-known in the art.

Each pocket 101 is formed by attachment of front member 103 to rear member 105 by attachment seam 107. Each pocket has an opening 113 at the top of the pocket. Alternatively, the opening may be a single opening on the left, right, or bottom side of each pocket 101. In another alternative, each pocket 101 has multiple openings. Front surface 115 of rear member 105 preferably has a decorative appearance. Such appearance is desirable in the event that holder 100 is mounted without media in one or more pockets such that front surface 115 is visible through front member 103.

By way of example, holder 100 may be mounted as a border mid-way up on a bedroom wall, parallel to the floor, and running the length of the wall. Holder 100 has a linear series of pockets 101, separated by seams 107. Each pocket is used for displaying a different piece of media such as, for example, photographs, greeting cards, collectible trading cards, coins, small paper mache figurines, cassette tapes, compact discs, or the like. In this example embodiment of holder 100, rear surface 109 of rear member 105 includes a permanent adhesive layer 111, which permanently adheres holder 100 to the wall.

FIGS. 2A and 2B show another embodiment of the invention. As illustrated in FIG. 2A, the holder 200 includes a linear series of rectilinear plastic pockets 201 having a transparent front member 203 attached to a rear member 205. Front member 203 and rear member 205 preferably are constructed of material(s) that will not cause harm to media in pockets 201. For example, a low-acid, or acid-free, plastic will not cause colors of photographs held by pockets 201 to fade. Pockets 201 are separated and delineated by attachment seam 207. The means for forming attachment seams 207 between front member 203 and rear member 205 may be an adhesive, a thermal bonding process, a crimping process, some combination thereof, or other means suitable for permanently or removably attaching front member 203 to rear member 205. Each pocket 201 is formed by attachment of front member 203 to rear member 205 by seams 207.

As shown in FIG. 2B, which is a transverse cross-sectional view along line 2B-2B of FIG. 2A (not to scale), the rear surface 209 of rear member 205 includes an adhesive layer 211 used to adhere holder 200 to a wall or other substantially smooth mounting surface (not illustrated). Each pocket has an opening 213 at the top of the pocket. Alternatively, the opening may be a single opening on the left, right, or bottom side of each pocket 201, or there may be multiple openings in the pocket 201.

Seam 207 extends around the periphery of each pocket 201, forming a frame 214 around each pocket 201. Frame 214 may include materials having a design. The design may include, for example, a solid color, a mixture of colors, a pattern, lettering, numbering, or some combination thereof. Such a design may be printed on front surface 215 of rear member 205. The design may also be printed on front member 203. For purposes of illustration, a sample set of indicia including some examples of designs are depicted in frame 214 of FIG. 2A.

By way of one example of a use (not shown), holder 200 may be removably adhered to a refrigerator door. In such an application, each pocket 201 is used to display a picture of a child. A lettered message such as, for example, “Grandma's Sweethearts,” is printed on front member 203 in frame 214. In a further use of this exemplary embodiment, holder 200 may be removed from the refrigerator door and removably adhered to another mounting surface such as an office wall.

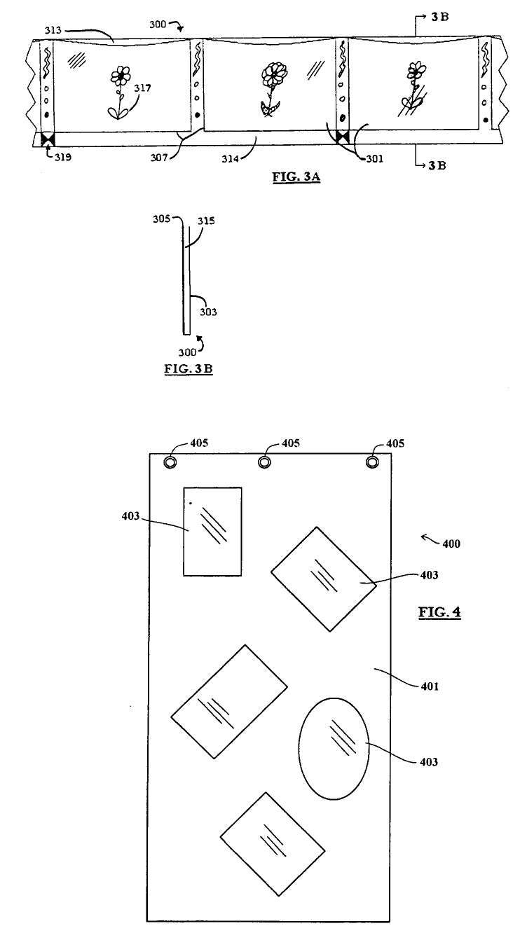

FIGS. 3A and 3B show yet another embodiment of a holder 300. FIG. 3B is a transverse cross-sectional view of FIG. 3A, along line 3B-3B (not to scale). The holder 300 has a series of pockets 301, each including a substantially transparent front member 303. In this embodiment, a design 317 is included in the pocket 301 portions of holder 300 surrounded by frame 314. As illustrated, the design 317 is printed on a front surface 315 of rear member 305. A second design 319 is included on the portion of frame 314 between the pockets 301. In alternative embodiments, either or both of designs 314 and 317 may be printed on front member 303, or on both front member 303 and front surface 315 of rear member 305.

FIG. 4 shows another alternative example of a holder, embodied as a banner 400. The banner 400 includes a rear base member 401 with an adhesive backing. A plurality of pockets 403 is removably adhered to the front surface of the rear base member 401. This configuration may alternatively be embodied as, for example, a wallpaper-style border. Each of the pockets 403 includes a substantially transparent front member and a rear member. The rear member may also be transparent. The pockets 403 each include an adhesive backing for mounting to the rear base member 401, and may include a variety of shapes (e.g., polygons, rounded shapes). The adhesive backing may, alternatively, be permanent. Those of skill in the art will appreciate that, in an alternative embodiment (not shown), each of the pockets 403 may be a substantially transparent front member. In such an embodiment, a pocket-space for displaying an item is formed behind the front member when a sufficient portion of the front member is adhered to the rear base member 401 (e.g., a seam of adhesive around three sides of a rectilinear pocket adheres the pocket to the rear base member).

The banner 400 offers a user broad latitude for individualized expression in arrangement of the pockets 403 and their user-chosen contents on the rear base member 401. A series of grommets 405 is included across the top end of the banner 400, and may be used for mounting the banner 400 using, for example, tacks, hooks, nails, or other well-known securing means instead of or in addition to an adhesive. Those of skill in the art will appreciate that the rear base member 401 and/or one or more of the pockets 403 may take a variety of shapes and may incorporate, for example, different colors, symbols, or designs. The banner 400 may also include non-adhesive means other than grommets such as—for example—hooks, magnets, or hook-and-loop connectors (e.g., Velcro®). Those of skill in the art will also appreciate that the banner 400 may be assembled by a user from its components included in a kit (which preferably includes a plurality of single- and/or double-layer pockets of different shapes and a rear base member, with some decorative indicia on one or both of pockets and rear base member). Alternatively, the banner may be manufactured in one or more of a pre-determined set of configurations with display pockets pre-placed on a rear base member.

It is therefore intended that the foregoing detailed description be regarded as illustrative rather than limiting, and that it be understood that it is the following claims, including all equivalents, that are intended to define the spirit and scope of this invention.

1. A display holder for displaying media, comprising:
a front member;
a rear member, further comprising:
a rear surface comprising an adhesive layer, said adhesive layer configured for removably adhering the holder to a substantially smooth first mounting surface;
wherein the front member is attached to the rear member in a manner forming a series of at least two pockets on a front surface of the rear member, each pocket having at least one open side.

2. The display holder of claim 1, wherein the front member comprises at least one pocket member.

3. The display holder of claim 1, wherein at least one of the pockets formed comprises the front member, the front surface of the rear member, and an open space therebetween for receiving an object to be displayed.

4. The display holder of claim 1, wherein at least one of the front member and the rear member includes a solid color, a mixture of colors, a pattern, lettering, numbering, or any combination thereof.

5. The display holder of claim 1, wherein the adhesive layer comprises a pressure-sensitive, medium tack adhesive.

6. The display holder of claim 5, wherein the pressure-sensitive, medium tack adhesive is configured to allow removal of the display holder from the first mounting surface and re-adherence to said first surface or adherence to a second mounting surface.

7. The display holder of claim 1, further comprising a non-adhesive means for mounting the holder to a second mounting surface.

8. A display holder kit for constructing a display holder, said kit comprising:
a plurality of front pocket members and
a base member comprising a rear surface with a first adhesive layer, said first adhesive layer configured for removably adhering the display holder to a first mounting surface;
said front pocket members comprising a second adhesive layer, adapted for mounting the front pocket members to the base member.

9. The display holder kit of claim 8, wherein the front pocket members or the base member include(s) a solid color, a mixture of colors, a pattern, lettering, numbering, or any combination thereof.

10. The display holder kit of claim 8, wherein the first adhesive layer comprises a pressure-sensitive, medium tack adhesive.

11. The display holder kit of claim 8, wherein the pressure-sensitive, medium tack adhesive is configured to allow removal of the display holder from the first surface and re-adherence to said first surface or to a different surface.

12. The display holder kit of claim 8, wherein the second adhesive layer comprises a pressure-sensitive, medium tack adhesive.

13. The display holder kit of claim 8, wherein the base member further comprises a non-adhesive means for mounting the holder to the first mounting surface or to a second mounting surface.

14. The display holder kit of claim 8, wherein at least one of the plurality of pocket members comprises a substantially transparent front member and a rear member.

15. The display holder kit of claim 8, wherein at least one of the plurality of pocket members comprises a substantially transparent front member.

16. A wall banner display comprising a plurality of pockets mounted to a base member, said base member being adapted to be removably mounted to a mounting surface by an adhesive.
